(19) United States
(12) Patent Application Publication
(10) Pub. No.: US 2010/0063226 A1
(43) Pub. Date: Mar. 11, 2010

(54) NORBORNENE-BASED POLYMER HAVING LOW DIELECTRIC CONSTANT AND LOW-LOSS PROPERTIES, AND INSULATING MATERIAL, PRINTED CIRCUIT BOARD AND FUNCTION ELEMENT USING THE SAME

(75) Inventors: Jae-Choon Cho, Suwon-si (KR); Do-Yeung Yoon, Seoul (KR); Jun-Rok Oh, Seoul (KR); Hwa-Young Lee, Suwon-si (KR); Sung-Taek Lim, Suwon-si (KR); Andreas Greiner, Marburg (DE)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/389,086

(22) Filed: Feb. 19, 2009

(30) Foreign Application Priority Data
Sep. 11, 2008 (KR) 10-2008-0089758

(51) Int. Cl. C08F 132/08; C08F 2/00

(52) U.S. Cl. 526/120; 526/281

(57) ABSTRACT

The present invention relates to a to a norbornene-based polymer having a low dielectric constant and low-loss properties, and an insulating material, a printed circuit board and a functional device using the same. More particularly, it relates to a norbornene-based polymer expressed by the following formula (1):

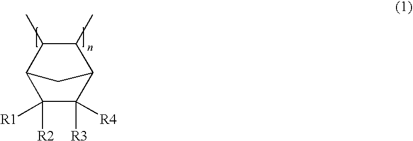

wherein, at least one of R1 to R4 is independently substituted or unsubstituted linear C4-C31 arylalkyl or substituted or unsubstituted branched C4-C31 arylalkyl;
the rest of R1 to R4 are each and independently H, substituted or unsubstituted linear C1-C3 alkyl, or substituted or unsubstituted branched C1-C3 alkyl; and
n is an integer of 250 to 400.

### CROSS-REFERENCE TO RELATED APPLICATIONS

This application claims the benefit of Korean Patent Application No. 10-2008-0089758 filed with the Korean Intellectual Property Office on Sep. 11, 2008, the disclosure of which is incorporated herein by reference in its entirety.

### BACKGROUND

1. Technical Field

The present invention relates to a to a norbornene-based polymer having a low dielectric constant and low-loss properties, and an insulating material, a printed circuit board and a functional device using the same. More particularly, it relates to a norbornene-based polymer expressed by the following formula (1):

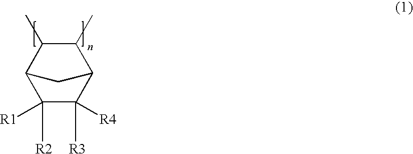

wherein, at least one of R1 to R4 is independently substituted or unsubstituted linear C4-C31 arylalkyl or substituted or unsubstituted branched C4-C31 arylalkyl;

the rest of R1 to R4 are each and independently H, substituted or unsubstituted linear C1-C3 alkyl, or substituted or unsubstituted branched C1-C3 alkyl; and

n is an integer of 250 to 400,

and a method for manufacturing the same.

2. Description of the Related Art

Growth of integrated circuits has allowed miniaturization of circuits and further allowed multifunctional and high performing products with high integration. Accordingly, interposers, packages, and printed circuit boards, etc. for providing electrical connection between integrated circuits mounted and another component have moved toward high integration. All components have been mounted on the surface of a board in conventional multilayer boards. However, there has been a large demand for embedded PCBs with higher densities, greater capabilities and smaller sizes in which a great number or a part of components are incorporated into internal layers. A package or board providing size reduction by 3-dimensional mounting of components and improved electrical performance at a high frequency is called as an embedded PCB.

Embedded printed circuit boards are multilayer printed circuit boards in which semiconductors and passive components are mounted and have high density, high performance and/or high frequency characteristics. Minicaturization of integrated circuits with high density(large-scale integration) has been developed for the demand of smaller, thiner and lighter weight of electronic devices and has been possible with ultra-fine wirings of integrated circuits. However, due to concerns of reducing electric power consumption and mounting of chip components, embedded PCBs, in which passive components are used and of which passive components are directly incorporated into internal layers, have been more demanded. Low loss dielectric(LLD) is a board material to be used as insulating materials or functional devices (e.g., filter, etc.) of radio frequency embedded boards. Lower cross talk and lower transmission loss is required for electronic devices with smaller in size and higher in frequency. Accordingly, there is a demand for researches on new insulating materials with low dielectric property and low loss and thus suitable for high frequency packaging and modules, etc. Materials having high Q value for embedding a filter and the like inside the package are also required for miniaturization. Low loss dielectrics play roles of insulating between wirings or between functional devices in the embedded PCB and of maintaining the strength of packages. Much higher-density wirings are also required in packages along with using ultra-fine wirings and operation of high density integrated circuits at higher frequencies. Since such high density wirings may cause noises between wirings, dielectric constant of insulating materials, parasitic capacitance and loss of dielectric have to be lowered to reduce insulating damages.

Benzocyclobuten(BCB) has been used for its excellent properties but cannot be suitable for printed circuit boards due to high cost. Liquid crystalline polymer(LCP) has also excellent properties but causes problems in the processing of printed circuit boards due to characteristics of thermoplastic resin. Therefore, it is highly demanded to develop new materials having insulating properties and processability.

### SUMMARY

An aspect of the invention is to provide a novel norbornene-based polymer having low dielectric constant and processability as a low loss dielectric material, which is applicable for the material of embedded boards (e.g., insulating materials or functional elements), and an insulating material, a printed circuit board and a functional elements using the same.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a graph illustrating a dielectric constant of the polymer prepared according to Example 1 of the invention.

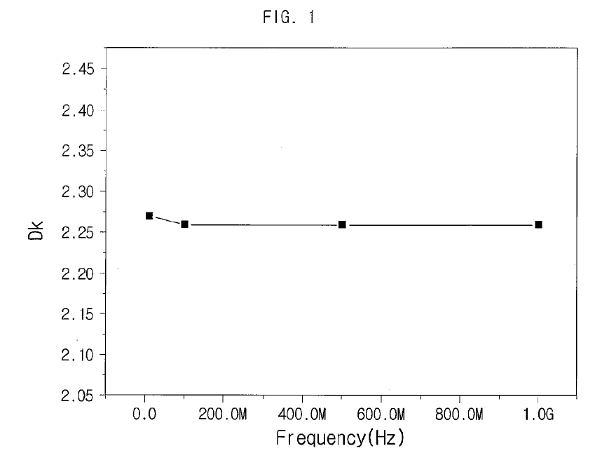

FIG. 2 is a graph illustrating a dielectric loss tan δ value of the polymer prepared according to Example 1 of the invention.

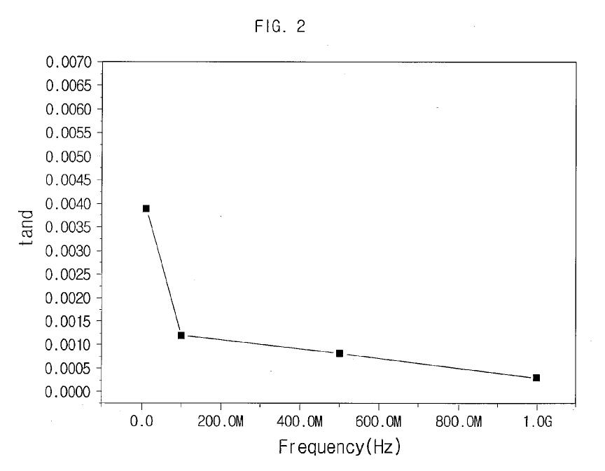

FIG. 3 is a graph illustrating a pyrolysis onset temperature of the polymer prepared according to Example 1 of the invention.

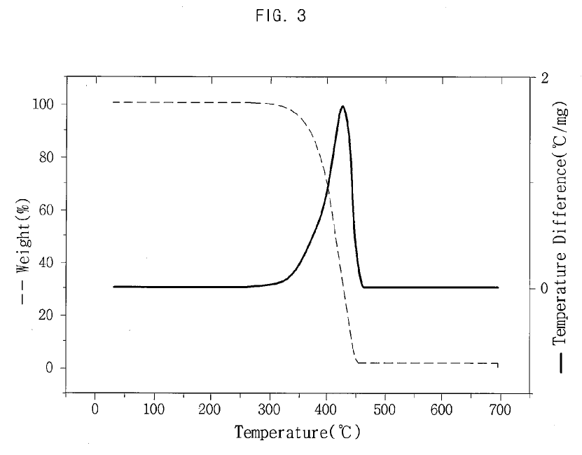

FIG. 4 is a graph illustrating a glass transition temperature of the polymer prepared according to Example 1 of the invention.

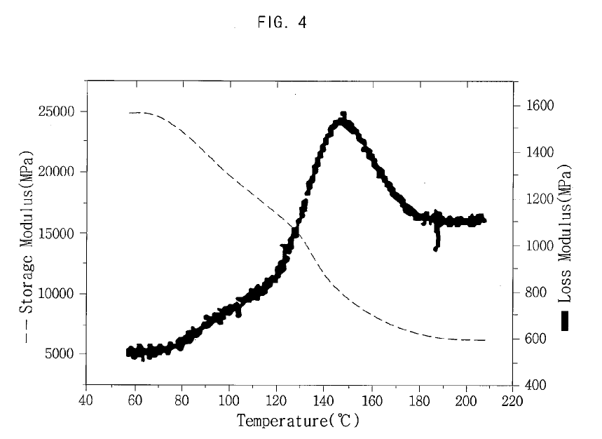

FIG. 5 is a ¹H NMR spectrum of the 2-(4-phenylbutyl)-5-norbornene monomer prepared according to Example 1 of the invention.

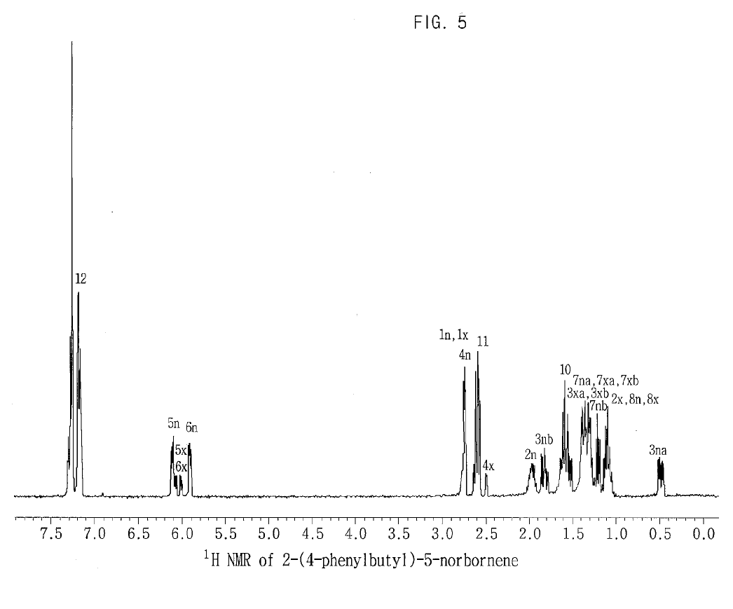

### DETAILED DESCRIPTION

The invention has been developed by preparing various norbornene-based polymers through the polymerization of various norbornene derivatives and conducting experiments to determine dielectric contants, dielectric loss factors, pyrolysis onset temperatures and glass transition temperatures of those polymers to provide novel insulating materials having low dielectric constant and processability as well as low loss property.

The term “norbornene-based” in the invention is a monomer including at least one norbornene moiety of the following structure A or a polymer formed from such monomers or a polymer including at least one repeat unit of the following structure B.

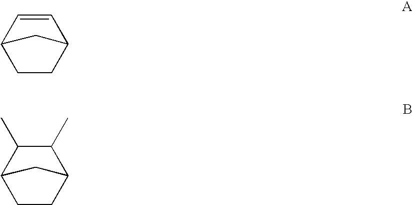

The term “addition polymerization of norbornene derivatives” is an addition polymerization reaction to provide a polymer containing a repeat unit which is able to bond through the 2,3-bonding of a double bond in the norbornene derivative monomer of the following structure A. Such polymers can be produced from norbornene-based monomers under a Group VIII transition metal system as disclosed in WO97/20871 (Publication date: Jun. 12, 1997), the disclosure of which is incorporated herein by reference in its entirety.

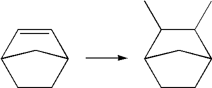

The term “low loss dielectrics” can be used as an insulating material in various electronic components and be also an electrical insulating material having high-frequency transmission characteristics which exhibits low transmission loss at a high frequency region.

According to an aspect of the invention, there is provided a norbornene-based polymer of the following formula 1 to solve the problems described above:

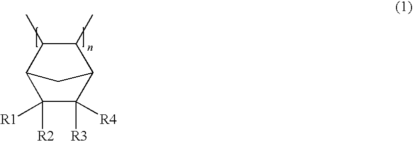

wherein, at least one of R1 to R4 is independently substituted or unsubstituted linear C4-C31 arylalkyl or substituted or unsubstituted branched C4-C31 arylalkyl;

the rest of R1 to R4 are each and independently H, substituted or unsubstituted linear C1-C3 alkyl, or substituted or unsubstituted branched C1-C3 alkyl; and

n is an integer of 250 to 400.

According to an embodiment of the invention, the arylalkyl may be expressed by the following formula 2:

-L-Ar (2)

wherein, L is substituted or unsubstituted linear C1-C7 alkylene or substituted or unsubstituted branched C1-C7 alkylene; Ar is one chosen from substituted or unsubstituted C3-C24 aryl, polyaryl, and heteroaryl.

According to an embodiment of the invention, the norbornene polymer may be expressed by the following formula 3:

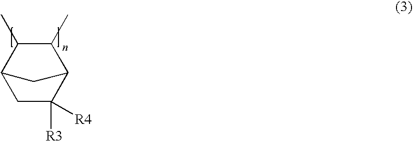

wherein, one of R3 and R4 is substituted or unsubstituted C4-C31 arylalkyl; and n is an integer of 250 to 400.

According to an embodiment of the invention, the arylalkyl may be one chosen from the following examples.

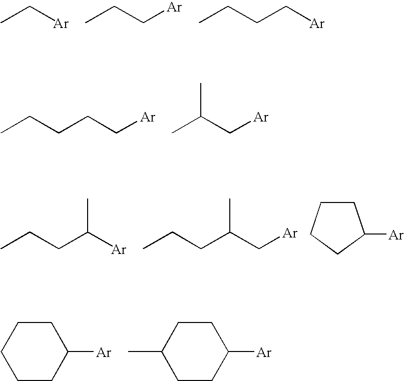

According to an embodiment of the invention, the norbornene polymer may be expressed by the following formula 4:

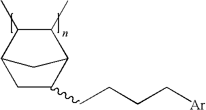

wherein, Ar is one chosen from substituted or unsubstituted C3-C24 aryl, polyaryl, and heteroaryl, and n is an integer of 250 to 400, and the wave line may include both exo- and endo-isomers.

Particular examples of the aryl group in the arylalkyl group may include the following phenyls, polyaryls and heteroaryls.

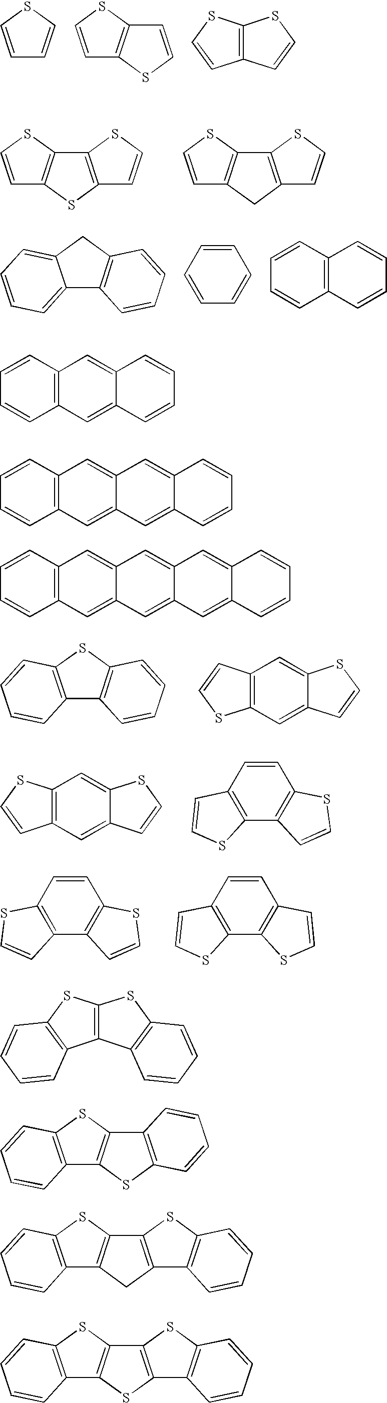

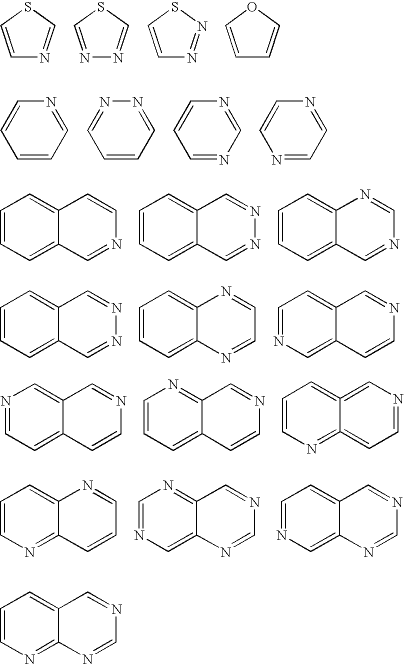

The phenyl, polyaryl and heteroaryl may be substituted or unsubstituted.

According to an embodiment of the invention, the norbornene-based polymer may be expressed by the following formula 5:

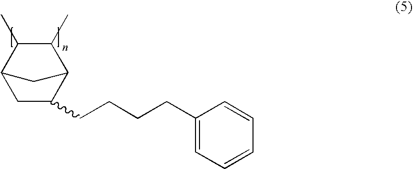

wherein, n is an integer of 250 to 400.

The compound of formula (5) may be prepared by various methods. For example, a norbornene-based polymer may be prepared by preparing a monomer of a repeat unit by the following Scheme 1 and polymerizing the monomers.

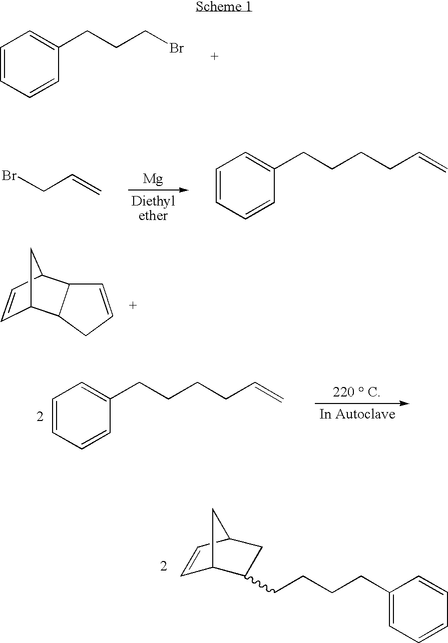

According to an embodiment of the invention, the norbornene-based polymer may be expressed by the following formula 6:

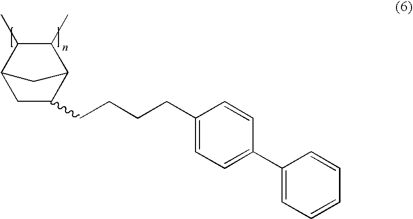

wherein, n is an integer of 250 to 400.

The compound of formula (6) may be prepared by various methods. For example, a norbornene-based polymer may be prepared by preparing a monomer of a repeat unit by the following Scheme 2 and polymerizing the monomers.

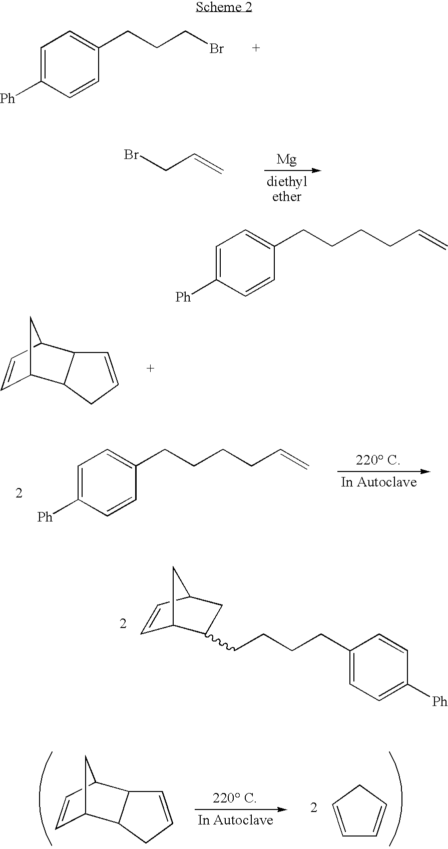

The norbornene-based polymer of the invention may have a dielectric constant of 2.48 at 1 GHz to 2.53 at 1 GHz, a dielectric loss tangent(tan δ) of 0.0003 at 1 GHz to 0.0005 at 1 GHz, a pyrolysis onset temperature(Td5) of 350° C. to 355° C., and a glass transition temperature of 160° C. to 170° C. as described above. The norbornene-based polymer may not only maintain its own low dielectric characteristics but also exhibit excellent processability due to aryl groups bonded in contant intervals.

The film prepared with the polymer according to an embodiment of the invention may begin pyrolysis at 350° C. or higher and have the glass transition temperature of 240° C. or higher so that it may have thermal and mechanical stabilities. Further, such prepared film may be transparent and flexible and exhibit good adhesion during the spin coating.

The norbornene-based polymer may be used as a low loss dielectric material.

According to another aspect of the invention, there is provided an insulating material formed by using the norbornene-based polymer. The insulating material may be used in embedded printed circuit boards or functional devices. The dielectric constant of the insulating material may be in the range of 2.48 at 1 GHz to 2.53 at 1 GHz and the dielectric loss factor may be in the range of 0.0003 at 1 GHz to 0.0005 at 1 GHz.

A method for manufacturing organic substrates does not require a sintering process so that the manufacturing method can be simplified.

Further, the insulating material may be used as a resin of substrates and when it is used as a resin of a substrate, it may reduce noises between patterns and insulation losses. The insulating material may be used in any structure requiring a low dielectric property such as fillers of a substrate, insulating layers of a substrate and glass fibers without any limitation.

Further, the insulating material may be used in the embedded boards and functional devices in which a great number or a part of components can be embedded.

According to another aspect of the invention, there is provided an embedded printed circuit board or functional device including the insulating material of the invention.

According to another aspect of the invention, there is provided a method for manufacturing a norbornene-based polymer including: preparing a Pd(II)-based catalyst; preparing a monomer; and polymerizing the monomers by using the Pd(II)-based catalyst.

An example of the Pd(II)-based catalyst may include (6-methoxybicyclo[2.2.1]hept-2-en-endo-5σ,2π)-palladium(II) hexafluoroantimonate.

Accordingly the norbornene-based polymer of the invention exhibits low dielectric constant, low loss properties and excellent processability so that it is able to be used as an insulation material in embedded boards or functional devices.

Hereinafter, although more detailed descriptions will be given by examples and preparation examples, those are only for explanation and there is no intention to limit the invention.

### EXAMPLE 1

### (1) Synthesis of Catalyst

### (Bicyclo[2.2.1]hepta-2,5-diene)dichloro palladium(II)

Platinum chloride(II) (1.97 g, 11.1 mmol) was dissolved in 5 mL of concentrated HCl solution at 50° C. After 1 hour, the reaction solution was cooled to room temperature, diluted with 100 mL of ethanol, filtered and washed with 50 mL of ethanol. Norbornadiene (2.7 mL, 25 mmol) was slowly added to the reaction solution with vigorous stirring. Yellow solid was precipitated out. After vigorous stirring for 10 minutes, the precipitates were filtered and washed with diethyl ether. Yellow powder was dried under vacuum to provide (bicyclo[2.2.1]hepta-2,5-diene)dichloro palladium(II).

Yield: 2.85 g (95.3%)

mp: 192˜198° C. (decomposed)

¹H NMR (DMSO-d⁶): δ=6.76 (t, 4H), 3.55 (quin, 2H), 1.87 (t, 2H)

³C NMR (DMSO-d⁶): δ=143.1, 74.8, 50.4

### Di-μ-chloro-bis-(6-methoxybicyclo[2.2.1]hept-2-en-endo-5σ,2π)-palladium(II)

The obtained (bicyclo[2.2.1]hepta-2,5-diene)dichloro palladium(II) (0.545 g, 2.02 mmol) in 8 mL of dried methanol was stirred under Ar at a temperature of −60° C. to −40° C. Sodium methoxide solution (5.0 mL (0.5 M), 2.5 mmol) was slowly added to the reaction solution. After stirring for 45 minutes, white milky solution was filtered and the powder was washed with cold methanol and dried under vacuum to provide di-μ-chloro-bis-(6-methoxybicyclo[2.2.1]hept-2-en-endo-5σ,2π)-palladium(II).

Yield: 0.37 g (69.0%)

### (6-Methoxybicyclo[2.2.1]hept-2-en-endo-5σ,2π)-palladium(II) hexafluoroantimonate (catalyst I)

Equimolar amount of each of di-μ-chloro-bis-(6-methoxybicyclo[2.2.1]hept-2-en-endo-5σ,2π)-palladium(II) and AgSbF₆ was dissolved in chlorobenzene. AgSbF₆ solution was added to the solution of di-μ-chloro-bis-(6-methoxybicyclo[2.2.1]hept-2-en-endo-5σ,2π)-palladium(II) to provide in situ an active solution of (6-methoxybicyclo[2.2.1]hept-2-en-endo-5σ,2π)-palladium(II) hexafluoroantimonate (catalyst I). AgCl was removed by filtering with a syringe filter to provide (6-methoxybicyclo[2.2.1]hept-2-en-endo-5σ,2π)-palladium(II) hexafluoroantimonate (catalyst I).

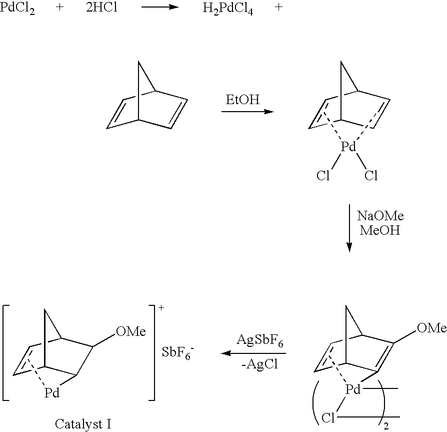

### (2) Synthesis of Monomer

### 6-Phenyl-1-hexene

A solution of 1-bromo-3-phenylpropane (126 g, 0.63 mol) was added by drop-wise to a magnesium (19 g, 0.78 mol) and iodo activator solution in 250 mL of diethyl ether and the reaction solution was stirred under N₂ at room temperature for 1 hour to provide a Grignard agent. After a solution of aryl bromide (106 g, 0.88 mol) in diethyl ether was added by drop-wise to the reaction solution under N₂, the reaction solution was refluxed for 2.5 hours. The reaction was quenched by adding 200 g of ice. The organic layer was washed with water, separated out, dried over sodium sulfate, filtered and evaporated under vacuum. The crude produce was purified by the vacuum distillation to provide 6-phenyl-1-hexene.

Yield: 96.1 g (95%);

bp: 64° C., 0.9 mbar;

¹H NMR (CDCl₃): δ=7.02-7.27 (m, 5H), 5.64-5.79 (m, 1H, J=9 Hz, J−6 Hz, J=3 Hz), 4.82-4.96 (m, 2H, J=3 Hz), 2.52 (t, 2H, J=6 Hz), 1.94-2.06 (m, 2H, J=6 Hz, J=9 Hz), 1.55 (qui, 2H, J=6 Hz), 1.35 (t, 2H, J=6 Hz, J=9 Hz);

¹³C NMR (CDCl₃): δ=142.6, 138.8, 128.4, 128.2, 125.6, 114.4, 35.8, 33.6, 30.9, 28.5

### 2-(4-Phenylbutyl)-5-norbornene

150 mL of a steel pressure vessel was charged with dicyclopentadien(46.65 g, 0.35 mol) and 6-phenyl-1-hexene(113 g, 0.71 mol) under Ar. The reaction solution was stirred for 1 hour and heated at 240° C. for 12 hours. The reaction solution was cooled and 6-phenyl-1-hexene was removed by evaporation. The residue was performed for the fractional distillation to provide 2-(4-phenylbutyl)-5-norbornene. Exo/endo mixture of 2-(4-phenylbutyl)-5-norbornene was produced by the Diels-Alder reaction of dicyclopentadien and 6-phenyl-1-hexene. When the reaction solution was heated to 100° C. or higher, dicyclopentadien was converted to cyclopentadien which reacted with 6-phenyl-1-hexene by the retro-Diels-Alder reacton. The Diels-Alder condensation of cyclopentadiene and an ethylene derivative provided 2 norbornene derivatives of exo and endo isomers. Here, most of cases endo isomer was preferable according to Alder's rule.

Yield: 52 g (33%);

bp: 130° C., 0.9 mbar;

¹H NMR (CDCl₃): δ=7.12-7.33 (m, 5H), 6.07-6.19 (m, 2H, J=2.7 Hz, J=2.9 Hz), 6.01-6.06 (m, 1H, J=2.7 Hz, J=2.9), 5.98(m, 1H, J=2.9 Hz, J=2.7 Hz), 2.73-2.88 (m, 4H), 2.55-2.68 (m, 2H, J=7.6 Hz), 1.94-2.08 (m, 1H, J=3.7 Hz, J=3.9 Hz), 1.80-1.93 (m, 1H, J=3.7 Hz, J=3.9 Hz), 1.61 (qui, 3H, J=7.6 Hz), 1.27-1.50 (m, 5H), 1.19-1.27 (m, 1H), 1.06-1.20 (m, 2H, J=2.9 Hz), 0.46-0.57 (m, 1H, J=2.7 Hz, J=2.9 Hz);

¹³C NMR (CDCl₃): δ=142.7, 136.5, 135.8, 132.0, 130.0, 127.9, 125.2, 49.2, 45.2, 44.9, 42.3, 38.5, 38.4, 36.1, 35.6, 34.3, 32.8, 32.1, 31.6, 28.3, 28.0

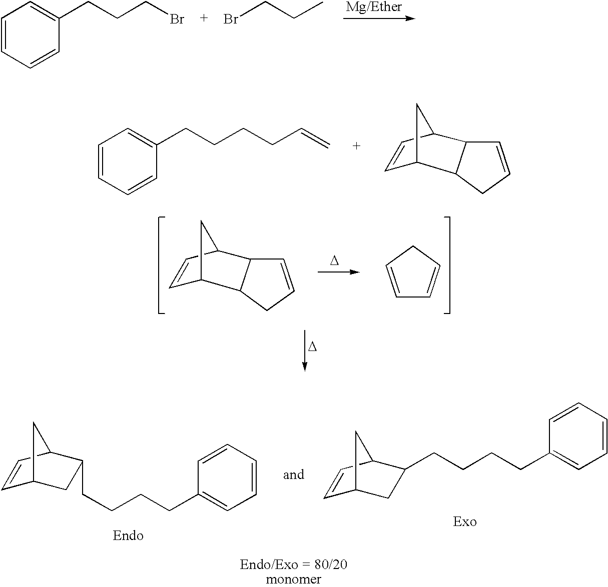

### (3) Synthesis of Polymer

### Poly(2-(4-phenylbutyl)-5-norbornene)

A monomer of 2-(4-phenylbutyl)-5-norbornene (1.0 g, 4.42 mmol) was dissolved in chlorobenzene under Ar. Each of AgSbF₆ and di-μ-chloro-bis-(6-methoxybicyclo[2.2.1]hept-2-en-endo-5σ,2π)-palladium(II) was dissolved in chlorobenzene. Equivalent amount of AgSbF₆ solution was added into a solution of di-μ-chloro-bis-(6-methoxybicyclo[2.2.1]hept-2-en-endo-5σ,2π)-palladium(II) to activate a catalyst. The activated catalyst I solution (monomer/Pd (II)=300, 1 Mₜₒₜₐₗ) was added into the monomer solution through a syringe filter to remove AgCl. After the reaction solution was stirred at room temperature under Ar for 24 hours, it was poured in methanol to precipitate polymer. The polymer was filtered and vacuum-dried at 60° C.

The polymer was dissolved in THF and stirred with H₂ balloon for 6 hours to remove the catalyst as disclosed by Okoroanyanwu et al. The dark aggregated catalyst residue was filtered through Celite 521 and the filtrate was concentrated. The polymer was precipitated out in methanol and the precipitate was dried under vacuum at 60° C. to provide a polymer product.

Yield: 0.81 g (81%)

### (4) Properties of Polymer

a) Molecular weight: Mₙ: 54,100, PDI: 1.5, M_{w}: 80,300

b) Degree of polymerization: 250 to 400 monomer unit

c) Tg: 160 to 170° C.

d) Thermal stability:

Td1 (° C.): 316 to 323 (d1=1% weight loss)

Td5 (° C.): 350 to 355 (d5=5% weight loss)

e) Refractive index: 1.54

f) Dielectric constant at 1 GHz: Dk: 2.48 to 2.53

g) Tan δ: 0.0003 to 0.0005

| | Film | Dielectric | Dielectric loss |
|---|---|---|---|
| Polymer | thickness(μm) | constant(at 1 GHz) | tangent(at 1 GHz) |
| Poly-A | 330 | 2.50 | 5.36 × 10⁻⁴ |
| Poly-A | 400 | 2.48 | 3.19 × 10⁻⁴ |
| Poly-A | 480 | 2.58 | 2.85 × 10⁻⁴ |
| Poly-A | 570 | 2.49 | 5.38 × 10⁻⁴ |

### * Property Determination

### ¹H NMR¹³C NMR

NMR spectrum was conducted by using the Bruker DPX-300 spectrometer at a probe temperature in CDCl₃. Chemical shifts were determined in parts per million(ppm) unit based on tetramethyl silane and coupling constants were determined in Hz unit.

Thermal Gravimetric Analysis(TGA)

Thermal gravimetric analysis was conducted by using TGA2050 of TA Instruments Inc. 10 mg of a polymer sample was weighted and heated to 700° C. under N₂ at a rate of 10° C./min.

Differential Scanning Calorimetry(DSC)

Differential scanning calorimetry was conducted by using DSC 2010 and DSC 2910 of TA Instruments Inc. Each 5 mg of a sample was used. Each sample was heated to 300° C. at a rate of 10° C./min and then cooled to 30° C. at a rate of 10° C./min. After the first scan of heating and cooling, each sample was conducted for the second scan with the same process.

Dynamic Mechanical Analysis(DMA)

DMA was conducted by using DMA2980 of TA Instruments Inc. A sample was dissolved in THF, coated on a glass fiber and dried under vacuum. The sample on the glass fiber was heated to 300° C. at a rate of 2° C./min and data was obtained under N₂ at dual-cantilever mode at a frequency of 1 Hz.

Molecular Weight Measurement

Molecular weight and polydispersity index of a polymer were determined by the gel permeation chromatography(GPC) using Jordi gel DVB mixed bed column of Alltech Associates, Inc. equipped with Alltech 426 HPLC pump and Waters 2410 refractive index detector. THF as an eluent was eluted at a rate of 1 mL/min. Polystyrene having molecular weight of 1,000 to 1,000,000 was used as a control for correction.

Refractive Index and Film Thickness

Refractive index was determined by using a thin film analyzer, Filmetrics F20 of Filmetrics, Inc. at a wavelength of 632.8 nm. SiO₂ on a Si-wafer standard sample (thickness=7254.7 Å) was tested prior to determining samples. The polymer was dissolved in cyclohexanone to be 12 wt. % solution, spin-coated on the Si-wafer for 30 seconds at 3000 rpm, and vacuum-dried at 60° C. for 1 day to obtain a uniform and homogeneous film on the Si-wafer.

Dielectric Constant and Dielectric Loss Tangent

Dielectric constant was determined by a MIM(metal-insulator-metal) parallel capacitance. The polymer film was prepared by the following method. Polymer powder was placed in a mold having two halves made of Teflon. The mold was pressed by a couple of stainless steel platens and heated at a vacuum oven to 160° C. for 4 hours. It was cooled with water and the two halves of the mold were removed from the film by pulling away. Dielectric constant and dielectric loss tan δ were determined by using a RF impedance/material analyzer, Agilent E4001A of Agilent Technologies Inc., at a range of 1 MHz to 1 GHz. The film was loaded to a test head and a fixing part.

### EXAMPLE 2

A monomer was prepared by the following Scheme which is a similar procedure in Example 1.

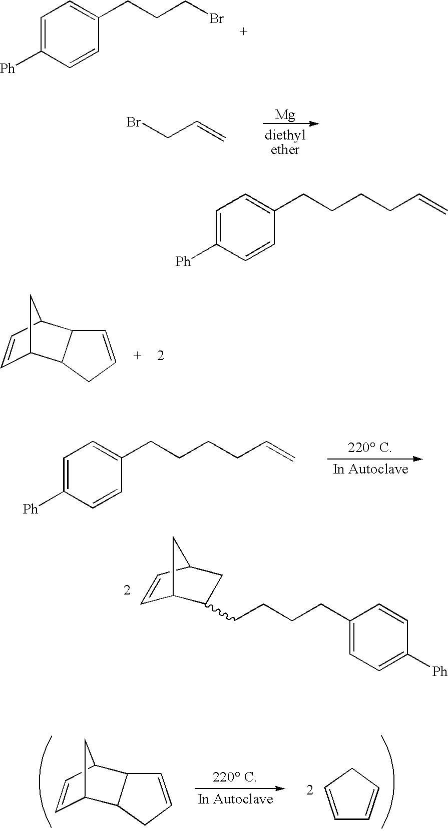

The monomer was polymerized by a similar method as described in Example 1. It was noted that the obtained polymer showed similar physical properties and electrical characteristics to those in Example 1.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A norbornene-based polymer having at least one repeat unit expressed by the following formula (1): 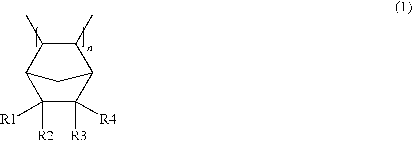
wherein, at least one of R1 to R4 is independently substituted or unsubstituted linear C4-C31 arylalkyl or substituted or unsubstituted branched C4-C31 arylalkyl;
the rest of R1 to R4 are each and independently H, substituted or unsubstituted linear C1-C3 alkyl, or substituted or unsubstituted branched C1-C3 alkyl; and
n is an integer of 250 to 400.

2. The norbornene-based polymer of claim 1, wherein the arylalkyl is a compound expressed by the following formula 2:
-L-Ar (2)
wherein, L is substituted or unsubstituted linear C1-C7 alkylene or substituted or unsubstituted branched C1-C7 alkylene; Ar is one selected from the group consisting of substituted or unsubstituted C3-C24 aryl, polyaryl, and heteroaryl.

3. The norbornene-based polymer of claim 1, wherein the norbornene-based polymer is a compound expressed by the following formula 3: 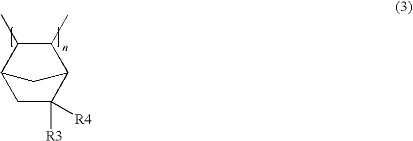
wherein, one of R3 and R4 is substituted or unsubstituted C4-C31 arylalkyl; and n is an integer of 250 to 400.

4. The norbornene-based polymer of claim 1, wherein the norbornene-based polymer is a compound expressed by the following formula 4: 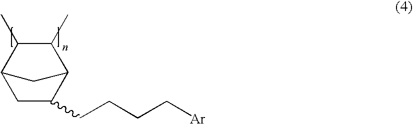
wherein, Ar is one selected from the group consisting of substituted or unsubstituted C3-C24 aryl, polyaryl, and heteroaryl; and n is an integer of 250 to 400.

5. The norbornene-based polymer of claim 1, wherein the norbornene-based polymer is a compound expressed by the following formula 5: 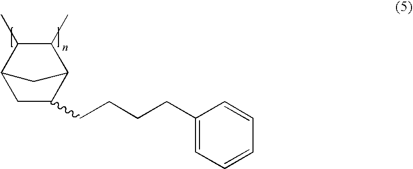
wherein, n is an integer of 250 to 400.

6. The norbornene-based polymer of claim 1, wherein the norbornene-based polymer is a compound expressed by the following formula 6: 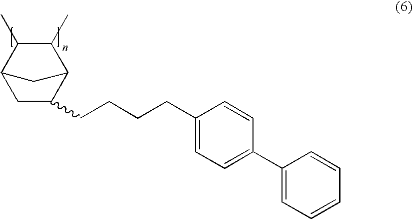
wherein, n is an integer of 250 to 400.

7. An insulating material using the norbornene-based polymer of claim 1.

8. The insulating material of claim 7, wherein the insulating material is used for embedded printed circuit boards or functional devices.

9. The insulating material of claim 7, wherein the dielectric loss factor of the insulating material is in the range of from 2.48 at 1 GHz to 2.53 at 1 GHz.

10. An embedded printed circuit board comprising the insulating material of claim 7.

11. A functional device comprising the insulating material of claim 7.

12. A method for manufacturing the norbornene-based polymer of claim 1 comprising:
preparing a Pd(II)-based catalyst;
preparing a monomer; and
polymerizing the monomers by using the Pd(II)-based catalyst.

13. The method of claim 11, wherein the Pd(II)-based catalyst is (6-methoxybicyclo[2.2.1]hept-2-en-endo-5σ,2π)-palladium(II)hexafluoroantimonate.
